(19) United States
(12) Patent Application Publication
(10) Pub. No.: US 2005/0065823 A1
(43) Pub. Date: Mar. 24, 2005

(54) Method and apparatus for privacy checking

(75) Inventors: Sankaralingam Ramraj, San Jose, CA (US); Scott T. Luan, Palo Alto, CA (US); Aaron J. Schuman, Mountain View, CA (US)

Correspondence Address: Siemens Corporation;Intellectual Property Department, 170 Wood Avenue South, Iselin, NJ, 08830, US

(73) Assignee: Siemens Medical Solutions USA, Inc.

(21) Appl. No.: 10/668,557

(22) Filed: Sep. 23, 2003

(51) Int. Cl. G06F 17/60

(52) U.S. Cl. 705/3

(57) ABSTRACT

The preferred embodiments described herein provide a method and system for monitoring confidential information in a medical records system. The monitoring may occur when the data is transferred in the medical records system, such as inputting data into the medical records system, outputting data from the medical records system, displaying data on the medical records system, or saving data in the medical records system. The method and system for monitoring confidential information may extract a portion of data transferred, compare the portion of data with a predetermined sequence in a database, determine whether the portion of data comprises patient information based on the comparison, and modify the portion of data if it comprises patient information. Extracting a portion of data may comprise parsing the data or may comprise reading a structured form. Further, comparing the portion of data with a predetermined sequence may comprise comparing the portion of data with a predetermined format. Alternatively, comparing the portion of data the portion of data with a predetermined sequence in a database and determining whether the portion of data comprises patient information may comprise using rules (such as an expert system) to specify a sequence of characters that includes patient information. Moreover, modifying the portion of data if it comprises patient information may comprise manual or automatic modification.

### BACKGROUND

Handling of personal patient information may prove difficult at times. On the one hand, a patient may wish to keep his or her unique information private. On the other hand, many parties, including doctors, nurses, hospital personnel, insurance agents, and others may require access to the personal patient information in order to provide efficient and/or effective administration.

In order to balance these potentially competing interests, various regulations direct how organizations may handle and use personal patient information. One such regulation, which applies to the medical industry, is the Health Insurance Portability and Accountability Act (HIPAA). It ensures patients' right to privacy by specifying confidentiality rules. These rules apply to a set of data called Patient Health Information (PHI), which includes the patient's name, Social Security Number, birthday, or any attribute which is unique to the patient.

Hospitals and corporations are liable for HIPAA violations. To reduce this liability, extensive measures may be adopted to ensure that certain medical documents or reports do not contain PHI. However, these measures may be problematic. Visual inspection may be time-consuming and tedious. Moreover, the number of regulations may be too complex and are subject to change. Finally, adherence of employees to HIPAA-compliant processes may not be flawless.

There is a need, therefore, for an improved method and system for monitoring patient information in a medical records system in an efficient and accurate manner.

### SUMMARY

The present invention is defined by the following claims, and nothing in this section should be taken as a limitation on those claims.

A system and method for monitoring patient information may review data in a medical records system for patient information. The review may occur when the data is transferred in the medical records system, such as inputting data into the medical records system, generating reports of the data, outputting data from the medical records system, displaying data on the medical records system, e-mailing the data, or saving data in the medical records system.

In one aspect, the patient information monitor may extract a portion of data transferred, compare the portion of data with a predetermined sequence in a database, determine whether the portion of data comprises patient information based on the comparison, and modify the portion of data if it comprises patient information. Extracting a portion of data may comprise parsing the data or may comprise reading a structured form. Further, comparing the portion of data with a predetermined sequence may comprise comparing the portion of data with a predetermined format. Alternatively, comparing the portion of data the portion of data with a predetermined sequence in a database and determining whether the portion of data comprises patient information may comprise using rules (such as an expert system) to specify a sequence of characters that includes patient information. Moreover, modifying the portion of data if it comprises patient information may comprise manual or automatic modification.

In another aspect, the patient information monitor may identify at least one characteristic of the data stream, determine whether the data stream comprises patient information based on the characteristic, and modify at least a portion of the data stream. Identifying a characteristic of the data stream may comprise determining whether the data stream comprises a form. Identifying a characteristic of the data stream may comprise identifying a field or tag in the data stream. The form, field, or tag may indicate which portion of the data stream may comprise patient information.

### BRIEF DESCRIPTION OF THE DRAWINGS

FIG. 1 is a block diagram of the hardware and operating environment of a suitable computer in a medical records system in conjunction with which embodiments of the invention may be practiced.

FIG. 2 is a flow chart of a method of one embodiment for implementing patient information monitor in the workflow of the medical records system disclosed in FIG. 1.

FIG. 3 is a flow chart of the patient information monitor disclosed in FIG. 2.

FIG. 4 is a block diagram of basic architecture of an expert system which may be implemented on the hardware and operating environment disclosed in FIG. 1.

FIG. 5 is a block diagram of an embedded workflow for the expert system disclosed in FIG. 4.

FIG. 6 is a sample input to the patient information monitor.

FIG. 7 is a sample output of the patient information monitor.

### DETAILED DESCRIPTION OF THE PRESENTLY PREFERRED EMBODIMENTS

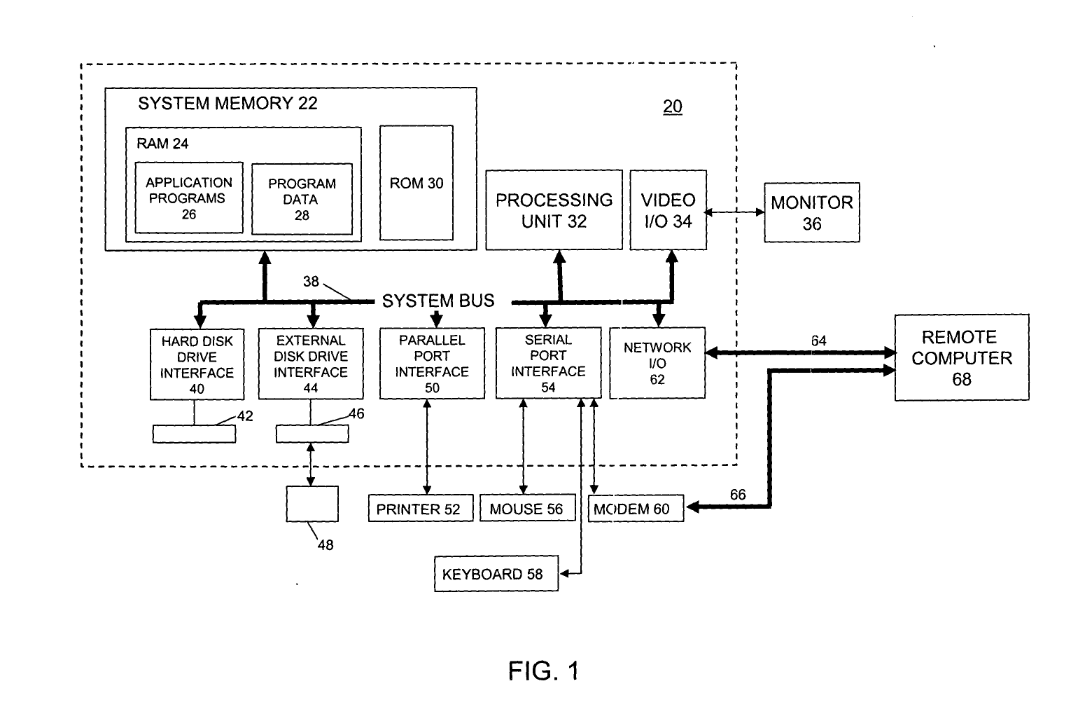

Turning to the drawings, FIG. 1 is a block diagram of the hardware and operating environment of a suitable computer in a medical records system in conjunction with which embodiments of the invention may be practiced. The medical records system may be implemented within a hospital, a doctor's office, an insurance company, or any environment which inputs, outputs, transfers or transmits patient information.

With reference to FIG. 1, an exemplary system for implementing the medical records system includes a general purpose computing device in the form of a computing environment 20, including a processing unit 32, a system memory 22, and a system bus 38, that couples various system components including the system memory 22 to the processing unit 32. The processing unit 32 may perform arithmetic, logic and/or control operations by accessing system memory 22. The system memory 22 may store information and/or instructions for use in combination with processing unit 32. The system memory 22 may include volatile and non-volatile memory, such as random access memory (RAM) 24 and read only memory (ROM) 30. A basic input/output system (BIOS) containing the basic routines that helps to transfer information between elements within the computer environment 20, such as during start-up, may be stored in ROM 30. The system bus 38 may be any of several types of bus structures including a memory bus or memory controller, a peripheral bus, and a local bus using any of a variety of bus architectures.

The computing environment 20 may further include a hard disk drive 42 for reading from and writing to a hard disk (not shown), and an external disk drive 46 for reading from or writing to a removable external disk 48. The hard disk and/or the external disk 48 may store patient information. The removable disk may be a magnetic disk for a magnetic disk driver or an optical disk such as a CD ROM for an optical disk drive. The hard disk drive 42 and external disk drive 46 are connected to the system bus 38 by a hard disk drive interface 40 and an external disk drive interface 44, respectively. The drives and their associated computer-readable media provide nonvolatile storage of computer readable instructions, data structures, program modules and other data for the computing environment 20. Although the exemplary environment described herein employs a hard disk and an external disk 48, it should be appreciated by those skilled in the art that other types of computer readable media which can store data that is accessible by a computer, such as magnetic cassettes, flash memory cards, random access memories, read only memories, and the like, may also be used in the exemplary operating environment.

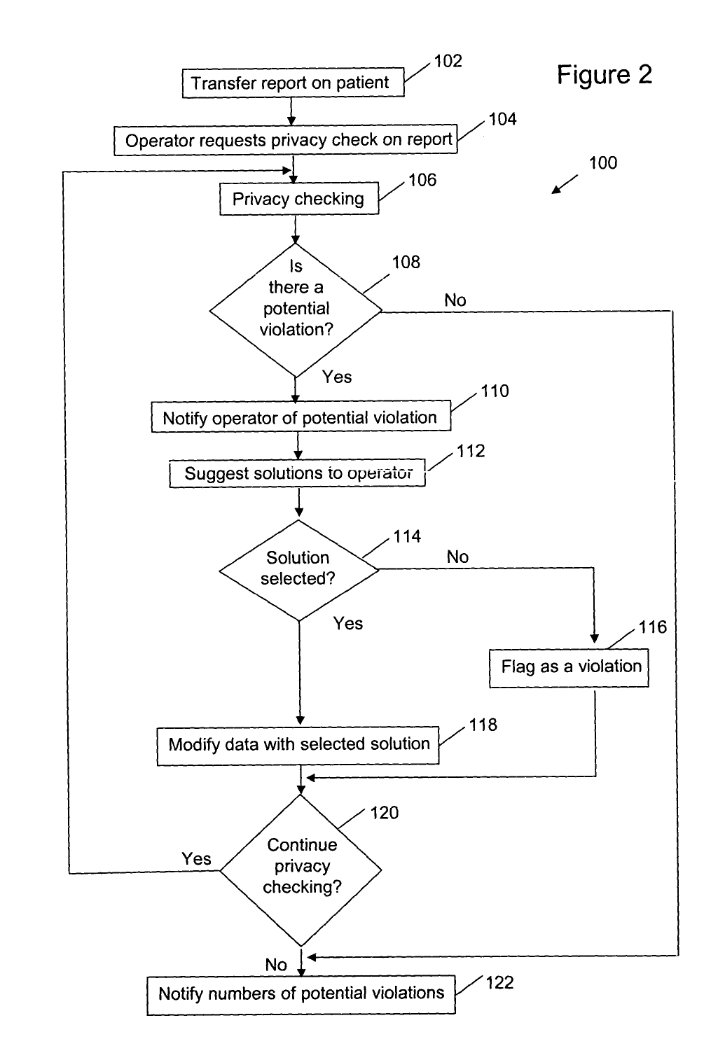

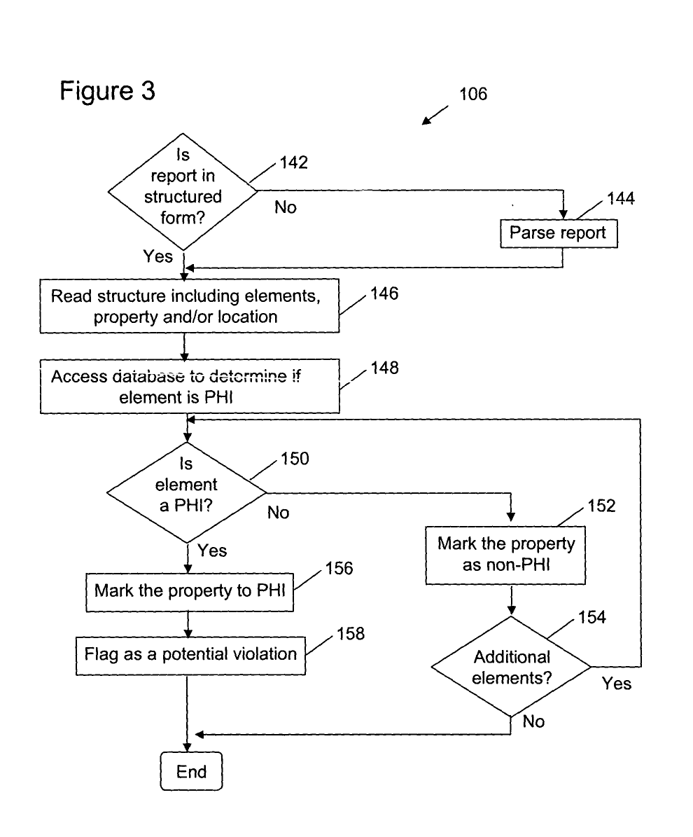

A number of program modules may be stored on the hard disk, external disk 48, ROM 30 or RAM 24, including an operating system (not shown), one or more application programs 26, other program modules (not shown), and program data 28. One such application program may include the patient information monitor as detailed in FIGS. 2 and 3. Further, a database used in conjunction with the patient information monitor may reside in program data 28.

A user may enter commands and/or information, as discussed below, into the computing environment 20 through input devices such as mouse 56 and keyboard 58. For example, the computing environment 20 may be a patient data entry console using the input devices to input patient data. Other input devices (not shown) may include a microphone (or other sensors), joystick, game pad, scanner, or the like. These and other input devices may be connected to the processing unit 32 through a serial port interface 54 that is coupled to the system bus 38, or may be collected by other interfaces, such as a parallel port interface 50, game port or a universal serial bus (USB).

Further, patient information may be output using different output devices. One such output device is printer 52. The printer 52, and other parallel input/output devices may be connected to the processing unit 32 through parallel port interface 50. Another such output device is monitor 36. The monitor 36, or other type of display device, is connected to the system bus 38 via an interface, such as a video input/output 34. In addition to the monitor 36, computing environment 20 may include other peripheral output devices (not shown), such as speakers or other audible output.

The computing environment 20 may exchange patient information, such as by sending or retrieving patient information, by communicating with other electronic devices such as remote computer 68. Remote computer 68 may be another computing environment such as a server, router, network PC, peer device, telephone (wired or wireless), personal digital assistant, television, or the like. Remote computer 68 may include many or all of the elements described above relative to the computing environment 20. To communicate, the computer environment 20 may operate in a networked environment using connections (wired, wireless or both wired and wireless) to one or more electronic devices. FIG. 1 depicts the computer environment networked with remote computer 68. The logical connections depicted in FIG. 1 include a local area network (LAN) 64 and a wide area network (WAN) 66. Such networking environments are commonplace in offices, enterprise-wide computer networks, intranets and the Internet.

When used in a LAN networking environment, the computing environment 20 may be connected to the LAN 64 through a network I/O 62. When used in a WAN networking environment, the computing environment 20 may include a modem 60 or other means for establishing communications over the WAN 66. The modem 60, which may be internal or external to computing environment 20, is connected to the system bus 38 via the serial port interface 54. In a networked environment, program modules depicted relative to the computing environment 20, or portions thereof, may be stored in a remote memory storage device resident on or accessible to remote computer 68. It will be appreciated that the network connections shown are exemplary and other means of establishing a communications link between the electronic devices may be used.

With reference to FIG. 2, there is show a flow chart 100 of a method of one embodiment for implementing patient information monitor in the workflow of the medical records system disclosed in FIG. 1. The patient information monitor may be implemented at any stage of the medical records system including transferring data within the medical records system, as shown at block 102. Transferring data within the medical records system may include inputting data into the medical records system (e.g., inputting patient data); generating a report comprising the data (e.g., generating a diagnosis of a patient, registration or scheduling for a patient, or a bill for a patient); outputting data from the medical records system (e.g., printing on printer 52, e-mailing to remote computer 68, retrieving from remote computer 68, transmitting to remote computer 68, faxing, etc.); displaying data on the medical records system (e.g., displaying on monitor 36); saving data in the medical records system (e.g., saving data to a database or to an external disk); etc. Thus, the patient information monitor may be integrated, where appropriate, in the medical records workflow to maintain acceptable levels of security, such as report generators, data input consoles, etc. The patient information monitor, similar to a spelling or grammar checker for common word processing programs, may check for any information which may be considered as confidential. Such information may include Personal Health Information (PHI) as designated by HIPAA.

The operator may request privacy checking in the report, such as a PHI check in the report, as shown at block 104. Privacy checking, such as PHI checking, may be initiated, as shown at block 106. The privacy checking may determine whether there is a potential violation of privacy, as shown at block 108. Block 108 is discussed in more detail in FIG. 3. If there is a potential violation, the operator may be notified of the potential violation, as shown at block 110. The privacy checking may suggest a single solution or suggest multiple solutions to the operator. The solutions may be previously input by the operator. For example, the operator prior to transferring the data may previously suggest the solution. Alternatively, the operator may suggest the solution after transferring of the data, but prior to requesting privacy checking.

There are several potential solutions which may be suggested including: encrypting the data; protecting the entire report (or a portion of the report) with a password; deleting a portion or all of the patient data; scrambling the patient data (such as by replacing the patient data with different characters, such as XXX); and/or modifying presentation of the patient data (such as changing the font, size, background, etc.).

The operator may select a solution, as shown at block 114. If the operator selects a solution, the transferred data may be modified, as shown at block 118. For example, if the operator opts to password protect the data, the operator may enter a password. If the operator elects not to select a solution, the report may be flagged as a potential violation, as shown at block 116. Alternatively, instead of requesting input from the operator, the patient data may be automatically modified by computing environment 20.

The data may then be checked for additional patient information, as shown at block 120. If there is additional information to be checked in the transferred data, the system may loop back to block 106. The program may resume PHI checking of the transferred data at the point where PHI checked left off in the previous iteration. Alternatively, the program may resume PHI checking from the beginning of the transferred data. On the next iteration, the operator need not be notified of potential violations which were modified or flagged in a previous iteration.

If there are no more potential violations or the privacy checker has checked all of the data transferred, the operator may be notified of the number of potential violations, as shown at block 122. Alternatively, the operator may be notified of the potential violations.

With reference to FIG. 3, there is shown a flow chart of the privacy checking in block 106 disclosed in FIG. 2. In one aspect, at least one characteristic of the data transferred may be determined. The characteristic may comprise whether the data transferred conforms to a particular structure or form. Alternatively or in addition, the characteristic may comprise whether a particular field or tag is present in the data transferred. Based on the characteristic, certain conclusions may be drawn. For example, if the data transferred conforms to a particular form, the template of the form may indicate which parts of the form comprise patient data. These parts may then be modified. As another example, a list of fields or tags which may indicate patient information may be stored in a database. The data transferred may be parsed to search for these fields or tags. If one of the fields or tags is present, the data associated with the field or tag may comprise patient information and may be modified. In another aspect, the data transferred may be parsed to search for patterns in the data transferred. If a pattern is identified as conforming to patient information, the pattern may be modified.

As shown in block 142, it is determined whether the data transferred, such as a report, is in structured form. Determining whether the data transferred is in structure form may be performed in a variety of ways including: parsing the data transferred to determine if it conforms to a predetermined form; parsing the data to determine if certain fields indicate the data transferred is in a predetermined form; determining from where the data was transferred (e.g., if input at a particular terminal, the data may be in a predetermined form).

If the data transferred is in structured form, this may indicate at least one characteristic of the data transferred. For example, once the form of the data transferred is determined, the elements (e.g., the data) in the form, the property (e.g., a field or tag indicating whether the element is PHI data) of the elements, and/or the location (e.g., location in the report) may be read, as shown at block 146. One example of a structured form is a DICOM (Digital Imaging and Communications in Medicine) structured report.

If the report is not in a structured form, the report may be parsed, as shown at block 144. Through parsing, the structure may be read to determine the elements, property, and/or location.

After which, the database may be accessed to determine if an element is private information, such as PHI data, as shown at block 148. The element, property, and/or location may be examined to determine whether the element comprises private information, as shown at block 150. As discussed in more detail below, there are several ways in which to determine whether an element is private information including: examining a characteristic of the data transferred (e.g., determining whether it conforms to a certain form, includes a certain tag or field, etc.); checking patterns in the transferred data; and/or using a rule-based system (such as an expert system) to identify private information. If the data transferred is in a particular form, the particular form may be accessed in the database to determine what portions of the form, if any, may contain patient data. For example, a DICOM structured report may include predetermined sections in the form which contain the patients name, address, etc. If the data transferred has certain properties associated with it, such as a particular field or a tag, the database may be reviewed for the particular field or tag. The database may indicate that data associated with the particular field or tag comprises patient information.

If the element is private information, such as PHI data, the property is marked as PHI data, as shown at block 156. A flag is also set as a potential violation so that block 108 in FIG. 2 may determine that there is a potential violation. If the element is not private information, such as non-PHI data, the property is marked as non-PHI data, as shown at block 152. Moreover, it is determined whether there are additional elements in the report, as shown at block 154. If there are additional elements, the flow chart loops back to block 150. If there are no additional elements, the flow chart ends.

As discussed above, there are a variety of ways to check for private information. In one embodiment, the privacy checker tool may monitor the transferred data, such as monitoring user input or parsing a report, to look for characters which conform to specific formats or patterns. An exemplary pattern is shown below:
f.last (name)
(###)###-#### (Telephone number)
###-##-#### (SS number)

Patterns may be checked in a variety of ways. One way is to use the scripting language PERL. Denoted as regular expressions in PERL, the above-referenced patterns are, respectively:
m/\hat{ }(\w+)(?:,\s*([A-Z]))?$/
m/\((\d {3})\)\s*\d{3}-\d{4}/
\d{3}\-\d{2}\-\d{4}

Alternatively, the privacy checker tool may search for fields, tags, etc. in the transferred data. The examples above demonstrate that the patient information monitor may use rules to specify which sequence of characters may be confidential. The set of rules may be larger than that included in the example above. To check for HIPAA compliance, the privacy checker may include complex rules and may resemble, in software design, an expert system.

Expert systems, in the most general definition of the term, are software whose behavior is the result of inferences based on declarative “if-then” rules. These rules may form a complex basis for automated reasoning. The design and implementation of expert systems are heavily researched fields in the discipline of artificial intelligence. Expert systems exist for numerous applications from thermodynamics modeling (TEST) to legal research (SHYSTER). There are readily available frameworks and tools to build an expert system including JESS (Java Expert System) and CLIPS (C Language Integrated Production System).

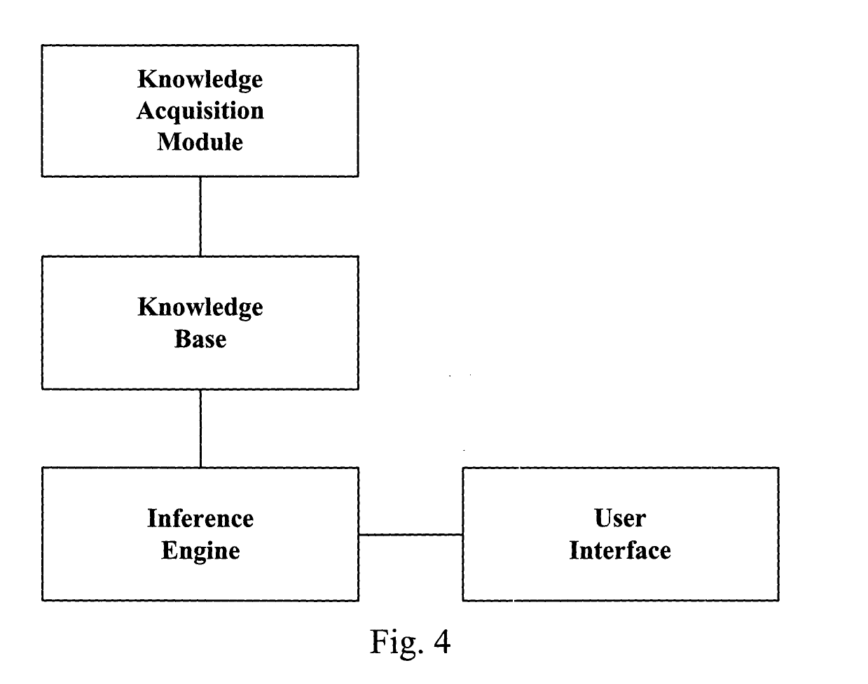

FIG. 4 shows a general architecture of an expert system. The Knowledge Acquisition Module 180 provides mechanisms for input of rules into the Knowledge Base 182. The Inference Engine 184 interacts with the User Interface 186 to produce results which are governed by data in the Knowledge Base 182. When executing the privacy checker, the Inference Engine 184 may access the Knowledge Base 182 to determine if a report contains private information. Further, the Inference Engine 184 may notify the operator of any information, including potential violations, via the User Interface 186.

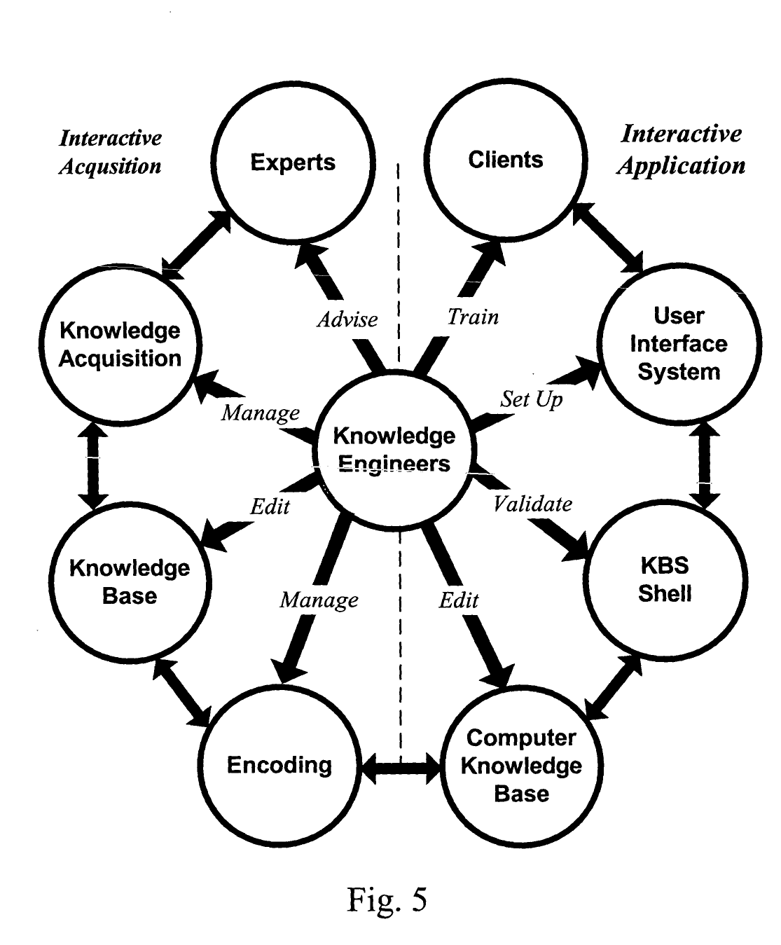

FIG. 5 depicts how an expert system may be integrated in a workflow which spans from expert-input during interactive acquisition to client-usage during interactive application. The management of the knowledge base may involve an ongoing process of acquiring and encoding its rules in order to reflect the current laws and regulations. Legal experts and engineers may manage and validate the knowledge. As shown in FIG. 5, Knowledge Engineers 200 may advise Experts 202, manage Knowledge Acquisition 204, edit the Knowledge Base 206, manage Encoding 208, edit the Computer Knowledge Base 210, validate the KBS Shell 212, set up the User Interface System 214, and train the Clients 216. The user interface may take the form of a graphical user interface (GUI) or shell (Knowledge Base Shell, KBS) which allows the user to tailor the behavior of the inference engine and integrate it to applications and clients in the medical imaging workflow which may require a privacy checker such as report generators or patient data entry consoles.

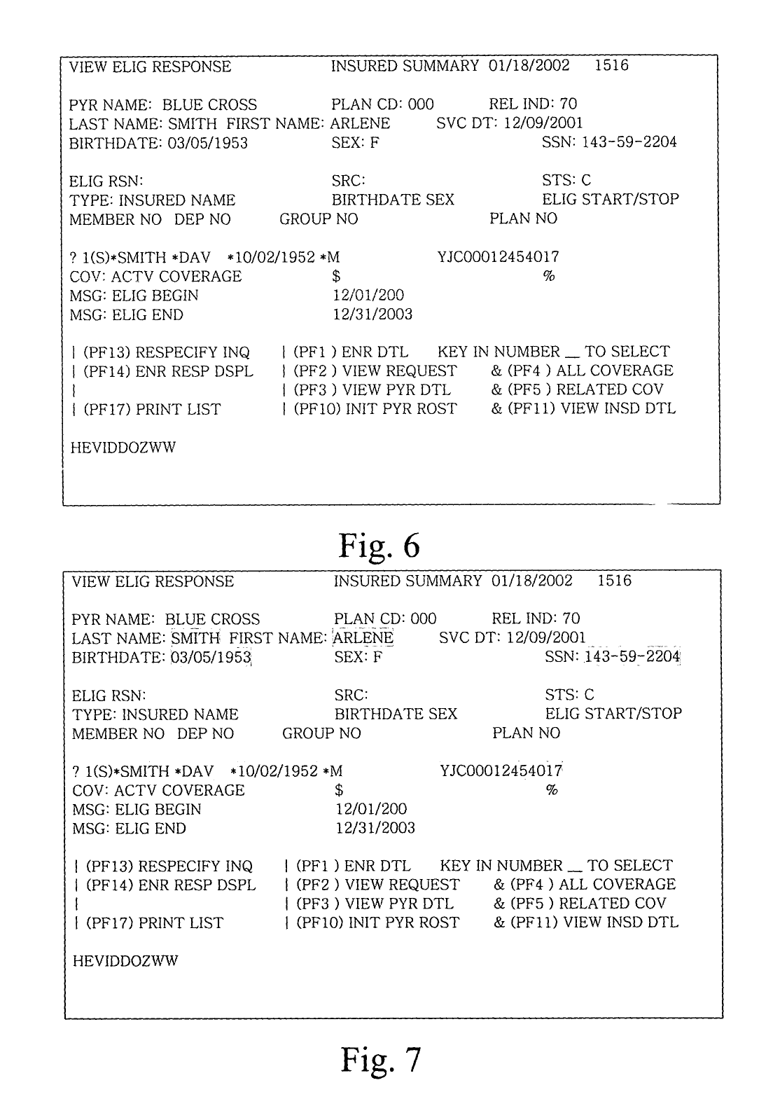

As discussed above, the privacy checker can take as input a report that may contain confidential information. An example of this is shown in FIG. 6. The report in FIG. 6 may indicate that the report is in a particular form, that the report includes particular tags or fields, or that the report includes data that matches certain patterns. For example, if the report indicates that it is in a particular form, a database may indicate, for the particular form, which portions of the report include patient information. The particular form may determine which parts of the data transferred in FIG. 6 are modified as shown in FIG. 7. As another example, a field or tag may indicate that it includes patient information. The particular field may indicate a name. If so, the data associated with the field (usually the data immediately after the field in the data stream) is presumed to be the name and is therefore modified. As still another example, if the data stream includes a pattern, such as ###-##-####, it may indicate a social security number, and is therefore modified, as shown in FIG. 7.

The output of the inference engine may be used to: notify the user of any (potential) HIPAA (or other patient privacy) violations via the GUI; identify the source of the violation via the GUI (i.e. font and format changes, blinks, voice, helping agent, etc) (see, for example, FIG. 7); allow the operator to correct violations by suggesting alternatives; automatically or manually modify the report in order to render it compatible to privacy regulations; and/or display the count of violations with or without identifying the violations. Furthermore, the privacy checker may be integrated with the patient data entry consoles so that it checks keystrokes and immediately warns the user that a sequence of characters may be confidential data.

Each of the acts in the method shown in FIGS. 2 and 3 can be performed by executing computer-readable program code stored on computer-usable media (e.g., one or more memories or disk drives). Further, it is intended that the foregoing detailed description be understood as an illustration of selected forms that the invention can take and not as a definition of the invention. It is only the following claims, including all equivalents, that are intended to define the scope of this invention.

1. Method for checking for patient information in a data stream in a medical records system comprising:
transferring the data stream in the medical records system;
extracting a portion of data from the data stream;
automatically comparing the portion of data with a predetermined sequence in a database;
automatically determining whether the portion of data comprises patient information based on the comparison; and
modifying the portion of data if it comprises patient information.

2. The method of claim 1, wherein transferring the data stream in the medical records system comprises generating a report comprising the data stream.

3. The method claim 1, wherein transferring the data stream in the medical records system comprises inputting the data stream into the medical records system.

4. The method of claim 1, wherein transferring the data stream in the medical records system comprises sending the data stream to a peripheral device.

5. The method of claim 1, wherein extracting a portion of data from the data stream comprises parsing the data stream.

6. The method of claim 1, wherein automatically comparing the portion of data with a predetermined sequence in a database comprises automatically comparing the portion of data with a predetermined format.

7. The method of claim 1, wherein automatically comparing the portion of data with a predetermined sequence in a database and determining whether the portion of data comprises patient information based on the comparison comprises using rules to specify a sequence of characters that includes patient information.

8. The method of claim 7, wherein the rules comprise an expert system.

9. The method of claim 1, further comprising notifying a user of the portion of data which comprises patient information and suggesting options to modify the portion of data which comprises patient information, and
wherein modifying the portion of data comprises manually selecting one of the options to modify the portion of data.

10. The method of claim 1, wherein modifying the portion of data comprises modifying content of the portion of data.

11. The method of claim 1, wherein modifying the portion of data comprises modifying presentation of the portion of data.

12. The method of claim 11, wherein modifying presentation of the portion of data comprises modifying font of the portion of data.

13. The method of claim 1, wherein the patient information is selected from the group consisting of name, postal address, e-mail address, telephone number, social security number, and birthday.

14. Method for checking for patient information in a data stream in a medical records system comprising:
transferring the data stream in the medical records system;
automatically determining at least one characteristic of the data stream;
automatically determining whether a portion of data comprises patient information based on the characteristic; and
modifying the portion of data if it comprises patient information.

15. The method of claim 14, wherein the characteristic comprises whether the data stream is a particular form.

16. The method of claim 15, wherein automatically determining whether a portion of data comprises patient information based on the characteristic comprises determining, based on the particular form, whether the data stream comprises patient information.

17. The method of claim 14, wherein the characteristic comprises a particular field.

18. The method of claim 17, wherein the portion of data modified is associated with the particular field.

19. A computer-based system for monitoring patient information in a medical records system, said computer-based system comprising:
a transfer device for transferring a data stream in the medical records system;
a memory storing predetermined sequences of patient information; and
a processor being coupled to the memory and the transfer device, the processor comparing a portion of the data stream with at least one predetermined sequence in the memory and determining whether the portion of the data stream comprises patient information based on the comparison.

20. The computer-based system of claim 19, wherein the transfer device comprises an input device.

21. The computer-based system of claim 19, wherein the data stream comprises a generated report; and
wherein the transfer device comprises an output device.

22. The computer-based system of claim 19, wherein the memory further comprises rules; and
wherein the processor comparing a portion of data with at least one predetermined sequence in the memory and determining whether the portion of the data stream comprises patient information based on the comparison comprises using the rules to specify a sequence of characters that includes patient information.

23. The computer-based system of claim 19, wherein the processor modifies the portion of the data stream if it comprises patient information.

24. The computer-based system of claim 23, wherein the processor encrypts the portion of the data stream.

25. The computer-based system of claim 23, further comprising a display; and
wherein the processor modifies presentation of the portion of the data stream on the display.

26. The computer-based system of claim 19, wherein the processor notifies a user of the portions of the data stream comprising patient information and suggesting alternatives for the portions of the data stream comprising patient information.

27. A computer-based system for monitoring patient information in a medical records system, said computer-based system comprising:
a transfer device for transferring a data stream in the medical records system;
a memory storing predetermined sequences of patient information; and
a processor being coupled to the memory and the transfer device, the processor determining at least one characteristic of the data stream, determining whether a portion of data comprises patient information based on the characteristic, and
modifying the portion of data if it comprises patient information.

28. The computer-based system of 27, wherein the characteristic comprises whether the data stream is a particular form.
